(19) United States
(12) Patent Application Publication
(10) Pub. No.: US 2020/0099842 A1
(43) Pub. Date: Mar. 26, 2020

(54) IMAGE CAPTURING APPARATUS AND CONTROL METHOD THEREOF, AND STORAGE MEDIUM

(71) Applicant: CANON KABUSHIKI KAISHA, Tokyo (JP)

(72) Inventors: Tomokuni Hirosawa, Tokyo (JP); Yosuke Mine, Tama-shi (JP)

(21) Appl. No.: 16/572,049

(22) Filed: Sep. 16, 2019

(30) Foreign Application Priority Data
Sep. 21, 2018 (JP) 2018-178082

(51) Int. Cl. H04N 5/235; H04N 5/225; H04N 5/232

(52) U.S. Cl. CPC H04N 5/2353; H04N 5/2357; H04N 5/23212; H04N 5/2253

(57) ABSTRACT

An image capturing apparatus includes an area sensor in which photoelectric conversion elements are arranged two-dimensionally, the sensor having a plurality of regions; an exposure control unit that causes the area sensor to be exposed at a given exposure time so that accumulation ends at substantially the same time for the plurality of regions, and reads out, in order, image signals accumulated as a result of the exposure, and a focus detection unit that carries out focus detection using a signal read out from the area sensor, wherein the exposure control unit carries out control for prioritizing the readout of signals from the photoelectric conversion elements in a region or regions among the plurality of regions.

### BACKGROUND OF THE INVENTION

### Field of the Invention

The present invention relates to focus detection techniques in image capturing apparatuses.

### Description of the Related Art

A pupil-division phase difference focus detection method, in which focus detection pixels are provided in an image sensor, is known as an example of a conventional focus detection method for image capturing apparatuses. Configurations of a CMOS-type image sensor having a global electronic shutter function have also appeared.

To reduce the processing time for focus detection, Japanese Patent Laid-Open No. 2016-72695 discloses a method in which signals from focus detection pixels are read out first. Additionally, Japanese Patent Laid-Open No. 2007-184814 discloses a method for setting exposure times for each of a plurality of regions and then reading out signals, with the aim of increasing the dynamic range.

However, the global electronic shutter configuration is a configuration in which the accumulated pixel signals are transferred to respective memory units, and the transferred pixel signals are then read out sequentially. As such, a light leakage phenomenon arises, in which charges are produced in the memory units in the period leading up to the readout. Thus with the conventional techniques disclosed in the above-described patent documents, there is a problem in that the image signals are disturbed by the light leakage, which produces error in the focus detection.

### SUMMARY OF THE INVENTION

Having been achieved in light of the above-described problem, the present invention provides an image capturing apparatus capable of reducing focus detection error.

According to a first aspect of the present invention, there is provided an image capturing apparatus comprising: an area sensor in which photoelectric conversion elements are arranged two-dimensionally, the sensor having a plurality of regions; and at least one processor or circuit configured to function as the following units: an exposure control unit that causes the area sensor to be exposed at a given exposure time so that accumulation ends at substantially the same time for the plurality of regions, and reads out, in order, image signals accumulated as a result of the exposure; and a focus detection unit that carries out focus detection using a signal read out from the area sensor, wherein the exposure control unit carries out control for prioritizing the readout of signals from the photoelectric conversion elements in a region or regions among the plurality of regions.

According to a second aspect of the present invention, there is provided a method for controlling an image capturing apparatus, the apparatus including an area sensor that has photoelectric conversion elements arranged two-dimensionally and that has a plurality of regions, the method comprising: exposing the area sensor at a given exposure time so that accumulation ends at substantially the same time for the plurality of regions, and reading out, in order, image signals accumulated as a result of the exposure; and carrying out focus detection using a signal read out from the area sensor, wherein in the exposing, control is carried out for prioritizing the readout of signals from the photoelectric conversion elements in a region or regions among the plurality of regions.

Further features of the present invention will become apparent from the following description of exemplary embodiments with reference to the attached drawings.

### BRIEF DESCRIPTION OF THE DRAWINGS

FIG. 1 is a block diagram illustrating the overall configuration of the camera body of a digital camera serving as a first embodiment of an image capturing apparatus according to the present invention.

FIG. 2 is a diagram illustrating the configuration of a camera optical system.

FIG. 3 is a diagram illustrating the configuration of a focus detection optical system according to the first embodiment.

FIG. 4 is a diagram illustrating the formation of images on a focus detection sensor according to the first embodiment.

FIG. 5 is a diagram illustrating a positional relationship between focus detection regions in a viewfinder.

FIG. 6 is a flowchart illustrating a focus detection process according to the first embodiment.

FIG. 7 is a flowchart illustrating a readout order according to the first embodiment.

FIGS. 8A to 8C are diagrams illustrating sensor states according to the first embodiment.

FIG. 9 is a diagram illustrating the configuration of a focus detection optical system according to a second embodiment.

FIG. 10 is a diagram illustrating the formation of images on a focus detection sensor according to the second embodiment.

FIG. 11 is a diagram illustrating sensor states according to the second embodiment.

FIG. 12 is a diagram illustrating the configuration of a focus detection optical system according to a third embodiment.

FIGS. 13A to 13C are diagrams illustrating a baseline length of the focus detection optical system, and the formation of images on the focus detection sensor.

FIG. 14 is a flowchart illustrating a focus detection process according to the third embodiment.

FIG. 15 is a flowchart illustrating the calculation of accumulation control parameters for the next time, according to the third embodiment.

FIG. 16 is a diagram illustrating the configuration of a focus detection optical system according to a fourth embodiment.

FIG. 17 is a diagram illustrating a positional relationship between focus detection regions in a viewfinder.

FIG. 18 is a flowchart illustrating operations by a camera according to the fourth embodiment.

FIG. 19 is a flowchart illustrating operations for AE and AF processing according to the fourth embodiment.

FIG. 20 is a diagram illustrating an example of a composition according to the fourth embodiment.

FIGS. 21A to 21C are diagrams illustrating images of the composition illustrated in FIG. 20, obtained by the focus detection sensor.

FIGS. 22A to 22C are diagrams illustrating images of the composition illustrated in FIG. 20, obtained by the focus detection sensor, indicating an AF luminance calculation region.

FIGS. 23A to 23C are diagrams illustrating images of the composition illustrated in FIG. 20, obtained by the focus detection sensor, indicating an AF luminance calculation region.

FIG. 24 is a diagram illustrating an image obtained by a photometry sensor during defocus.

FIG. 25 is a diagram illustrating exposure timing when shooting under a flickering light source.

### DESCRIPTION OF THE EMBODIMENTS

Embodiments of the present invention will be described in detail hereinafter with reference to the appended drawings.

### First Embodiment

FIG. 1 is a block diagram illustrating the overall configuration of a camera body 150 of a digital camera serving as a first embodiment of an image capturing apparatus according to the present invention.

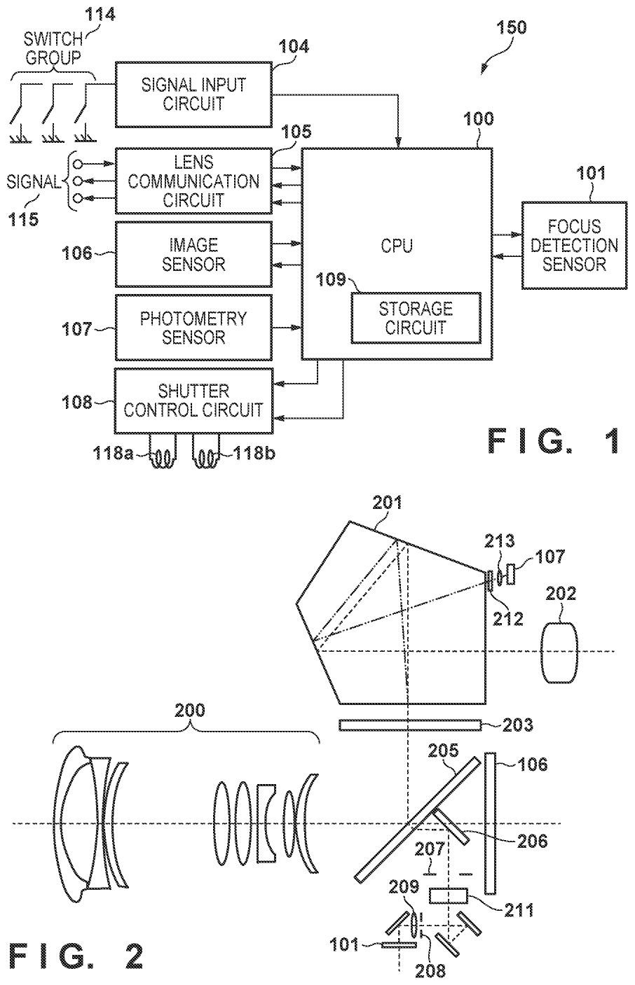

In FIG. 1, a signal input circuit 104, an image sensor 106 constituted by a CMOS sensor, a CCD, or the like, and a photometry sensor 107 are connected to a camera microcomputer (“CPU”, hereinafter) 100. The photometry sensor 107 is disposed partway along a viewfinder optical system, and includes an image sensor such as a CCD or a CMOS sensor. The photometry sensor 107 carries out object recognition processes, such as photometry processing, facial detection processing, tracking processing, and light source detection processing. The signal input circuit 104 senses a switch group 114 for making various camera operations. A shutter control circuit 108 for controlling shutter magnets 118a and 118b, and a focus detection sensor 101, are also connected to the CPU 100. Signals 115 are sent to a shooting lens 200 (illustrated in FIG. 2 and described later) through a lens communication circuit 105 to control the position of a focus lens and an aperture. Camera operations are set by a user operating the switch group 114. The switch group 114 includes a release button, a dial for selecting a focus detection region, and the like.

The focus detection sensor 101 is a CMOS image sensor (area sensor) in which pixels including photodiodes (photoelectric conversion elements) are arranged two-dimensionally, and is configured to be capable of global electronic shutter operations. In response to an instruction from the CPU 100 to start charge accumulation, the focus detection sensor 101 carries out circuit reset and photodiode reset operations, and starts charge accumulation operations.

An accumulation time over which charges are accumulated can be set individually on a region-by-region basis, and the accumulation times are determined by controlling the aforementioned circuit reset operations and photodiode reset operations on a region-by-region basis. However, it is desirable that the accumulation be set to end at the same time for all regions. The reason for this will be given later. Once an accumulation time set by the CPU 100 in advance has been reached, the charges accumulated in the photodiodes are (can be) transferred to memory units (not shown) that are part of the peripheral circuitry of the photodiodes. Once the charges have been transferred to the memory units in all of the pixels, the CPU 100 is notified that the charge accumulation has ended. This period, from the start of the accumulation to the end of the transfer of charges to the memory units, will be called an “accumulation state”.

Next, in response to a readout instruction from the CPU 100, the image signals accumulated and stored in the memory units during the accumulation state are read out on a region-by-region basis. Because signals from different regions cannot be read out at the same timing, it is necessary to read the signals out on a region-by-region basis. Light also strikes the memory units during the period from when the accumulation ends to when the signals are read out. This produces charges in the memory units, which are then added to the pixel signals transferred from the photodiodes. This phenomenon will be called “light leakage” hereinafter. This light leakage causes disturbances in the image signals, which produces error in the focus detection. It is desirable that the period from the end of accumulation to readout be shortened in order to reduce the amount of light leakage. This is why the accumulations are set to end at the same time for all regions, as mentioned above. The period in which the series of readouts are carried out as described above will be called a “readout state”.

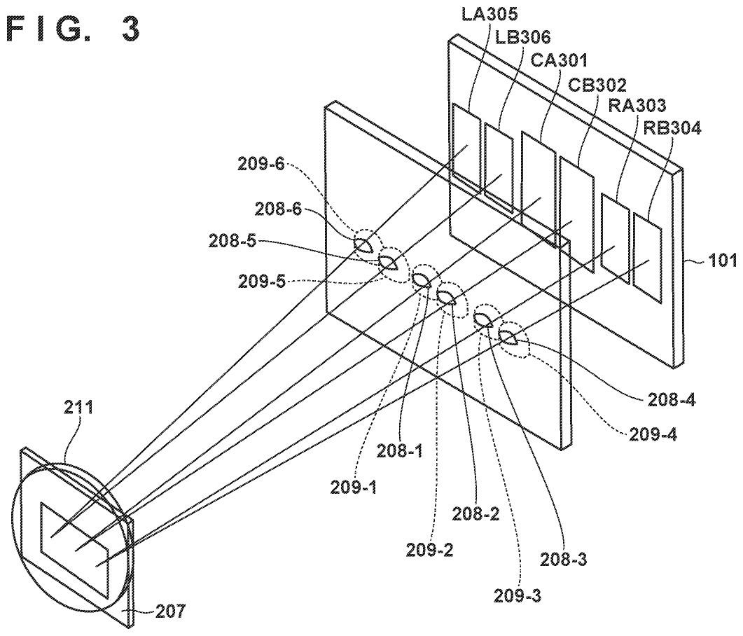

By the CPU 100 controlling the focus detection sensor 101, a pair of image signals having parallax relative to each other can be obtained through the optical system illustrated in FIG. 3, which will be described later. The focus state is detected from the phase difference in the obtained pair of image signals, and the focal position of the shooting lens 200 is controlled (a focus detection process).

The CPU 100 detects the luminance of an object by controlling the photometry sensor 107, and determines the aperture value, shutter speed, and so on of the shooting lens 200 (described later). The aperture value of the shooting lens 200 is controlled through the lens communication circuit 105, and the shutter speed is controlled by adjusting the electrification time of the magnets 118a and 118b through the shutter control circuit 108. Furthermore, shooting operations are carried out by controlling the image sensor 106.

A storage circuit 109, including ROM storing programs for controlling timers and camera operations, RAM for storing variables, EEPROM (electrically erasable programmable read-only memory) for storing various parameters, and the like, is built into the CPU 100.

The configuration of the optical system of the digital camera will be described next with reference to FIG. 2. A majority of light beams from an object, entering through the shooting lens 200, are reflected upward by a quick-return mirror 205, and an object image is formed on a viewfinder screen 203 as a result. The user can observe this image through a pentaprism 201 and an ocular lens 202.

Some of the light beams entering the pentaprism 201 form an image on the photometry sensor 107 through an optical filter 212 and an image forming lens 213. The object luminance can be measured by photoelectrically converting this image and processing the obtained image signal.

Some of the light beams from the object pass through the quick-return mirror 205, are bent downward toward a sub mirror 206 that follows, and form an image on the focus detection sensor 101 after passing through a visual field mask 207, a field lens 211, an aperture stop 208, and a secondary image forming lens 209. The state of focus of the shooting lens 200 can be detected by processing the image signals obtained by photoelectrically converting this image. During shooting, the quick-return mirror 205 and the sub mirror 206 are flipped up and retracted from the optical path, such that all incident light beams form an image on the image sensor 106 to expose the sensor with the object image.

In FIG. 2, a focus detection apparatus is constituted by the optical system from the visual field mask 207 to the secondary image forming lens 209 and the focus detection sensor 101. The focus detection method is a known phase difference detection method. The focus detection apparatus can detect the states of focus of a plurality of different focus detection regions.

FIG. 3 is a diagram illustrating the configuration of the optical system pertaining to focus detection in detail. The light beams from the object, reflected by the sub mirror 206, first form an image in the vicinity of the visual field mask 207 illustrated in FIG. 3. The visual field mask 207 is a light-blocking member for determining the focus detection region in the screen, and has a lengthwise opening in the center thereof.

The field lens 211 has an effect of causing each of openings in the aperture stop 208 to form images on corresponding partial regions of an exit pupil (pupil region) of the shooting lens 200. Secondary image forming lenses 209-1 to 209-6, constituted by three pairs corresponding to three focus detection regions, for a total of six lenses, are arranged behind the aperture stop 208. The secondary image forming lenses 209-1 to 209-6 are arranged so as to correspond to openings 208-1 to 208-6 in the aperture stop 208. The light beams passing through the secondary image forming lenses 209-1 and 209-2 form images on regions CA301 and CB302 of the focus detection sensor 101. Likewise, the light beams passing through the secondary image forming lenses 209-3 and 209-4 form images on regions RA303 and RB304, and the light beams passing through the secondary image forming lenses 209-5 and 209-6 form images on regions LA305 and LB306.

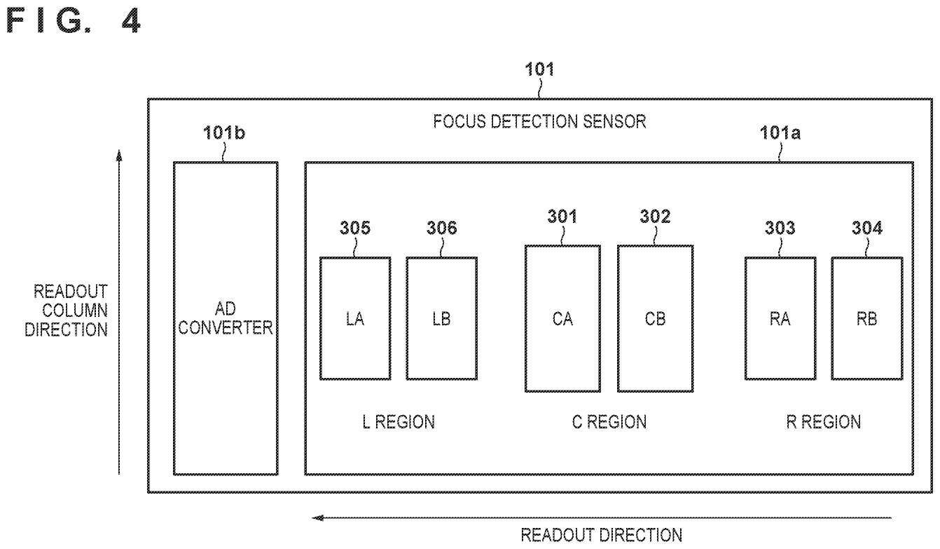

The configuration of the focus detection sensor 101 will be described next with reference to FIG. 4. The focus detection sensor 101 includes a pixel unit 101a, and an AD converter 101b that converts signals read out from the pixel unit 101a into digital signals. In the pixel unit 101a, charges are first accumulated, and the accumulated signals are then transferred to memory units arranged in the vicinity of corresponding pixels. Columns of the memory units (in FIG. 4, a column of memory units corresponding to a single vertical column of pixels) are read out in order, one column at a time, from the left to right. In other words, in the present embodiment, signals are read out one vertical column at a time, indicated in FIG. 4. This vertical direction (the shorter direction of the focus detection sensor 101) will be called a “readout column direction” in the present embodiment. The signals from the pixels (memory units) in each column are transferred in the horizontal direction by signal lines and input into the AD converter 101b. This horizontal direction (the longer direction of the focus detection sensor 101) will be called a “readout direction” in the present embodiment. Note that the focus detection sensor 101 can change the order of the readout columns as desired. Note also that the regions LA305 and LB306 of the focus detection sensor 101 indicated in FIG. 3 will be called “L regions”; the regions CA301 and CB302, “C regions”; and the regions RA303 and RB304, “R regions”.

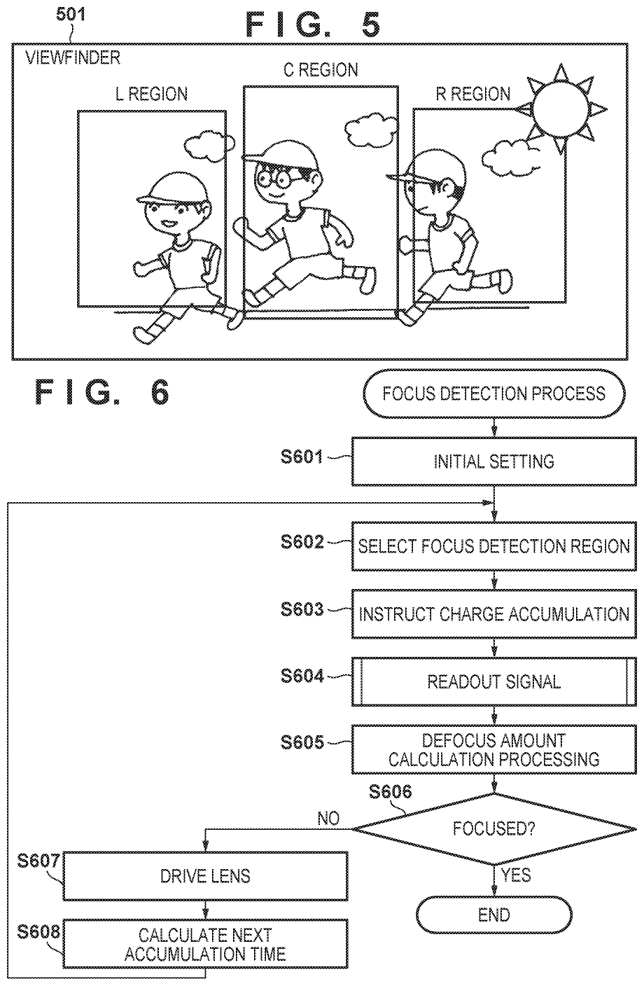

FIG. 5 is a diagram illustrating the positional relationship between focus detection regions in a viewfinder 501. The viewfinder 501 can be observed through the ocular lens 202. The focus detection regions corresponding to the L region, the C region, and the R region described in FIG. 4 are arranged in the viewfinder 501.

FIG. 6 is a flowchart illustrating the flow of the focus detection process according to the present embodiment. When the CPU 100 receives a focus detection start signal in response to the switch group 114 being operated, the CPU 100 controls the focus detection sensor 101 to start the focus detection process.

In step S601, the CPU 100 carries out initial settings for the focus detection process. The CPU 100 writes the initial settings into a register of the focus detection sensor 101, and sets the accumulation time for the initial accumulation. Additionally, a free selection mode in which a focus detection region selected by the user as desired is used, or an automatic selection mode in which a focus detection region selected automatically by the CPU 100 using a known algorithm, is set as a mode for the focus detection region (described later).

In step S602, the CPU 100 carries out the above-described focus detection region selection. The present embodiment assumes that at least one focus detection region is present in each of the C, R, and L regions. If the user has selected a focus detection region as desired in step S601, the selected focus detection region is determined to be a focus detection region corresponding to a main object region. If automatic selection by the CPU 100 is set, the CPU 100 selects the focus detection region automatically.

Methods such as the following can be given as examples of selecting the focus detection region automatically. One is a method in which the focus detection region with the focus position furthest on the near side is selected on the basis of a defocus amount calculated in step S605 (described later). Another is a method in which the focus detection region at a position determined to have the main object is selected based on the position of a face detected by the photometry sensor 107. In the initial focus detection process, and when the defocus amount could not be detected in step S605 (described later), the process may move to step S603 without selecting the focus detection region.

In step S603, the CPU 100 instructs the focus detection sensor 101 to start charge accumulation. Having received the instruction to start charge accumulation, the focus detection sensor 101 resets the circuitry and the photodiode, and starts the charge accumulation operations. The focus detection sensor 101 ends the charge accumulation operations once a predetermined amount of time has passed, and transfers the accumulated charges to the memory units corresponding to the respective pixels.

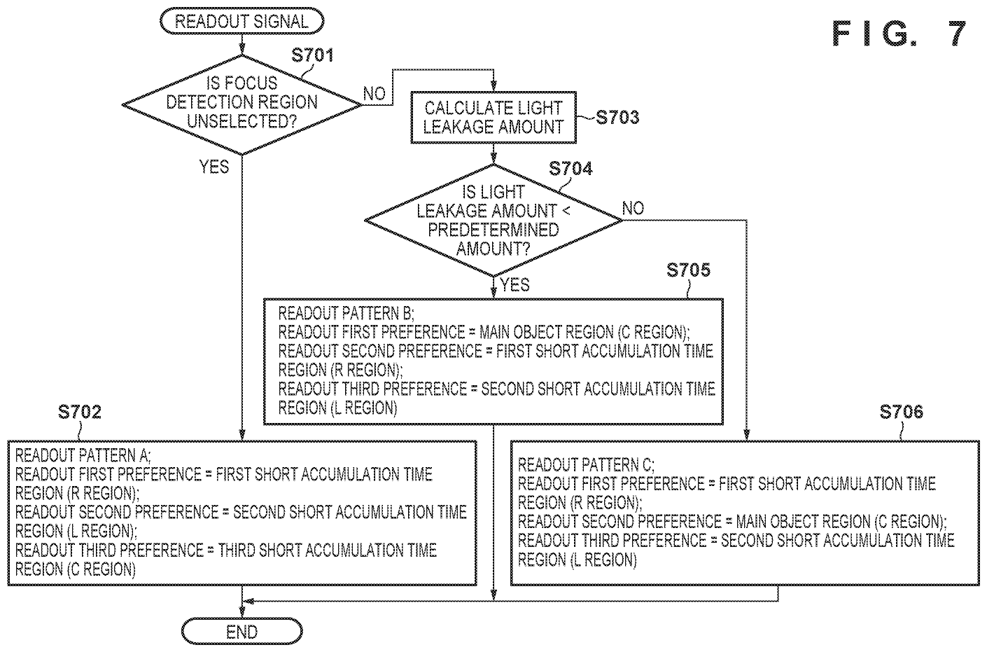

In step S604, the CPU 100 reads out the signals accumulated in step S603 and stored in the memory units. The signal readout will be described later with reference to the flowchart in FIG. 7.

In step S605, the CPU 100 calculates a defocus amount for the image signals read out in step S604. The calculation of the defocus amount is carried out through a known defocus computation, which detects the state of focus of the shooting lens 200 (the defocus amount) using a pair of image signals. Here, the defocus amount (mm) is found by multiplying the phase difference (bit number) of the focus detection sensor 101 by optical coefficients such as the sensor pitch (mm) and the baseline length of the focus detection system.

In step S606, the CPU 100 determines whether or not the shooting lens 200 is in focus on the basis of the defocus amount calculated in step S605. The lens is determined to be in focus if the defocus amount is within a desired range, e.g., within ¼Fδ (where F is the aperture value of the lens and δ is a constant (20 μm)). For example, if the lens aperture value is F=2.0, the lens is determined to be in focus if the defocus amount is 10 μm or less, and the focus detection process ends. However, if the defocus amount is greater than 10 μm, the lens is determined not to be in focus, and the process moves to step S607 in order to put the shooting lens 200 in focus.

In step S607, the CPU 100 instructs the shooting lens 200 to be driven on the basis of the defocus amount, through the lens communication circuit 105. In step S608, the CPU 100 calculates and sets the value of the accumulation time of the focus detection sensor 101 for the next focus detection process, on the basis of the object luminance. The CPU 100 then returns the process to step S602, and repeats the operations of steps S602 to S608 until the lens is determined to be in focus. The foregoing has described the flow of operations in the focus detection process.

Next, FIG. 7 is a flowchart illustrating the signal readout operations carried out in step S604 of FIG. 6.

In step S701, the CPU 100 determines whether the focus detection region is unselected or selected. The selection of the focus detection region is as described with reference to step S602 in FIG. 6. If the CPU 100 determines that the focus detection region is unselected, the process moves to readout pattern A in step S702, whereas if the CPU 100 determines that the focus detection region is selected, the process moves to a light leakage amount calculation in step S703.

In step S702, the CPU 100 reads out the signals in the order of the readout pattern A. In the readout pattern A, the signals are read out from the region having the shortest accumulation time, which is set on a region-by-region basis. Although the present embodiment describes determining the readout order using the accumulation time of the focus detection sensor 101, it should be noted that the object luminance output by the photometry sensor 107 may be used as well. If the readout order is determined using the object luminance, the readout is carried out from the region having the highest object luminance.

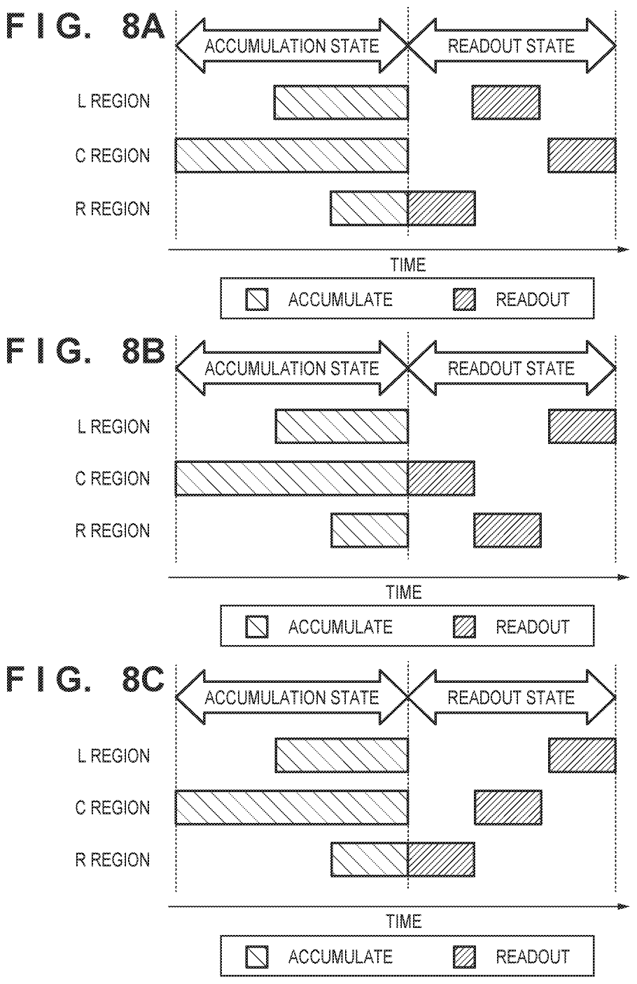

The readout pattern A will be described in detail using FIG. 5, which illustrates the relationship between the focus detection regions and the viewfinder 501, and FIGS. 8A to 8C, which illustrate sensor states. FIG. 5 illustrates an object observed through the viewfinder 501, whereas FIG. 8A illustrates an accumulation state and readout state of the focus detection sensor 101 with respect to the object illustrated in FIG. 5.

The object in FIG. 5 is a scene in which the R region has the highest object luminance, followed by the L region and the C region. In FIG. 8A, the accumulation time is set in accordance with the object luminance as described earlier with reference to step S608. As such, the R region has the shortest accumulation time, followed by the L region and the C region. Accordingly, in the readout pattern A of FIG. 8A, the R region, which has the shortest accumulation time, is read out first. The L region, which has the next-shortest accumulation time, is read out next, and the C region is read out last.

The readout is carried out in order from the shortest accumulation time in order to reduce light leakage arising in the memory units during the period spanning from the end of the accumulation to the readout. A region having a short accumulation time has a high object luminance and produces a charge in a short amount of time, which makes it easy for light leakage to arise. It is therefore necessary to shorten the period for which the signal is stored in the memory unit, spanning from the end of the accumulation to the readout. For these reasons, in the readout pattern A, the readout is carried out starting with the region having the shortest accumulation time.

Returning to the flowchart in FIG. 7, step S703 will be described next.

In step S703, the CPU 100 calculates the light leakage amount on a region-by-region basis. The light leakage amount can be calculated from the period spanning from the end of the accumulation to the readout by the focus detection sensor 101 and the object luminance calculated by the photometry sensor 107, or the accumulation time set for the focus detection sensor 101 by the CPU 100.

One example of the calculation method is a method in which the amount is calculated by multiplying the object luminance by sensor parameters such as the time from the end of the accumulation to the readout, the light-blocking performance of the focus detection sensor 101, and so on. It is also possible to calculate the amount from the accumulation time of the focus detection sensor 101 rather than the object luminance.

In step S704, the CPU 100 determines whether or not the light leakage amount is less than or equal to a predetermined amount. The determination is made on the basis of the light leakage amount calculated in step S703. If the amount is determined to be less than the predetermined amount, the process moves to readout pattern B in step S705, whereas if the amount is determined to be greater than or equal to the predetermined amount, the process moves to readout pattern C in step S706. Here, the “predetermined amount” is an amount at which the light leakage may affect the accuracy of the focus detection. As a specific example, the light leakage amount can be determined to have no effect on the accuracy of the focus detection as long as the amount is within an AD conversion error range.

In step S705, the CPU 100 reads out the signals in the order of the readout pattern B. In the readout pattern B, first, the region of the main object selected in step S602 is read out, after which the regions are read out in order from the region having the shortest accumulation time set on a region-by-region basis.

The readout pattern B will be described in detail using the sensor state illustrated in FIG. 8B. Like FIG. 8A, FIG. 8B illustrates the accumulation state and the readout state when the focus detection sensor 101 is driven, with respect to the object illustrated in FIG. 5. It is assumed that the main object is present in the C region.

In the readout pattern B, first, the C region in which the main object is present is read out first. Then, of the remaining R region and L region, the R region, which has the shortest accumulation time, is read out, followed by the L region. The main object is read out preferentially because carrying out the defocus computation process of step S605 preferentially for the region of the main object shortens the time required for the processing leading up to the lens driving in step S607, and shortens the time until the focus detection process is complete.

In step S706, the CPU 100 reads out the signals in the order of the readout pattern C. In the readout pattern C, first, a region determined in step S704 to have a light leakage amount greater than or equal to the predetermined amount is read out first. The region of the main object is read out next, followed by the remaining region.

The present embodiment describes a focus detection apparatus having three focus detection regions. However, if there are more than three regions, it is desirable that regions that are not main object regions and that have light leakage amounts less than or equal to the predetermined amount be read out from the region having the shortest accumulation time.

The readout pattern C will be described in detail using the sensor state illustrated in FIG. 8C. Like FIG. 8A, FIG. 8C illustrates the accumulation state and the readout state when the focus detection sensor 101 is driven, with respect to the object illustrated in FIG. 5. Here, it is assumed that the light leakage amount is greater than or equal to the predetermined amount in the R region, and that the main object is present in the C region. In the readout pattern C, the R region having a light leakage amount greater than or equal to the predetermined amount is read out first. The C region, in which the main object is present, is read out next, followed by the L region.

The region having a light leakage amount greater than or equal to the predetermined amount is read out preferentially because, as described earlier, the light leakage arises during the period from the end of the accumulation to the readout. This means that the light leakage amount increases later in the readout order, which worsens the accuracy of the focus detection. Accordingly, it is necessary to read out regions having a light leakage greater than or equal to the predetermined amount preferentially in order to prevent the focus detection accuracy from worsening.

As described thus far, setting the readout order of the focus detection sensor 101 to a readout order that prioritizes regions having a shorter accumulation time, which is set on a region-by-region basis, makes it possible to reduce the amount of light leakage and carry out a highly-accurate focus detection process.

### Second Embodiment

A second embodiment of the present invention will be described next. The first embodiment described a configuration in which in the focus detection optical system illustrated in FIG. 3, the light beams from the object are pupil-divided in a single direction. The second embodiment will describe a configuration in which the pupil division in the focus detection optical system is carried out in two different directions. The configuration of the camera and the focus detection process of the present embodiment are the same as in the first embodiment and will therefore not be described here.

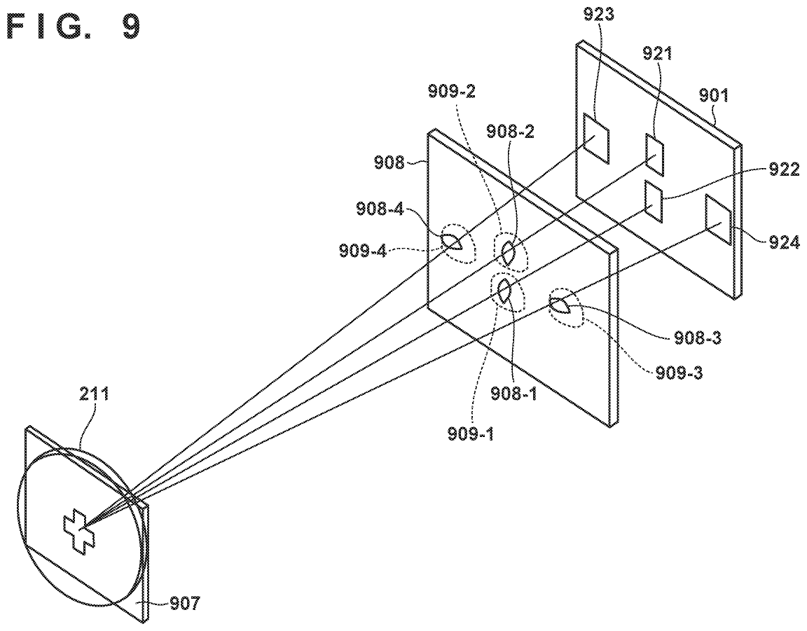

FIG. 9 is a diagram illustrating the configuration of the focus detection optical system according to the second embodiment. The light beams from the object, reflected by the sub mirror 206 illustrated in FIG. 2, first form an image in the vicinity of a visual field mask 907 illustrated in FIG. 9. The visual field mask 907 is a light-blocking member for determining the focus detection region in the screen, and has a cross-shaped opening in the center thereof.

The field lens 211 has an effect of causing each of openings in an aperture stop 908 to form images near the exit pupil of the shooting lens 200. Secondary image forming lenses 909-1 to 909-4, which are a total of four lenses constituting two pairs having different pupil division directions, are arranged behind the aperture stop 908, with each lens arranged so as to correspond to one of openings 908-1 to 908-4 in the aperture stop 908.

The light beams passing through the secondary image forming lenses 909-1 and 909-2 form images in regions VCA921 and VCB922 on a focus detection sensor 901. The light beams passing through the secondary image forming lenses 909-3 and 909-4 form images in regions HCA923 and HCB924 on the focus detection sensor 901.

An advantage of a configuration in which light beams that form images from two different directions is that contrast in each of the two directions can be detected. The defocus is computed from image signals in regions obtained at a high level of contrast, and thus the detection accuracy can be improved.

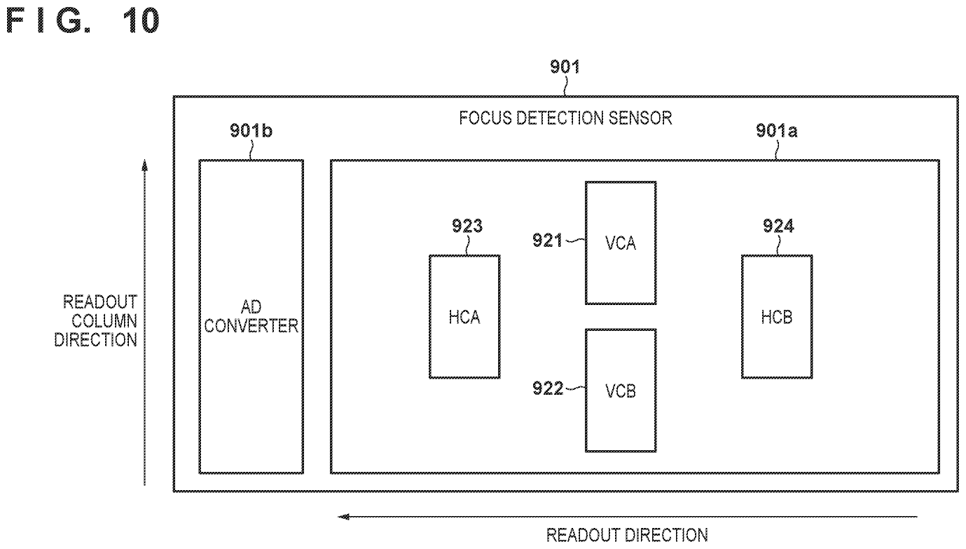

The configuration of the focus detection sensor 901 will be described next with reference to FIG. 10. The focus detection sensor 901 includes a pixel unit 901a, and an AD converter 901b that converts signals read out from the pixel unit 901a into digital signals. In the pixel unit 901a, charges are first accumulated, and the accumulated signals are then transferred to memory units arranged in the vicinity of corresponding pixels. Columns of the memory units (in FIG. 10, a column of memory units corresponding to a single vertical column of pixels) are read out in order, one column at a time, from the left to right. In other words, in the present embodiment, signals are read out one vertical column at a time, indicated in FIG. 10. This vertical direction (the shorter direction of the focus detection sensor 901) will be called a “readout column direction” in the present embodiment. The signals from the pixels (memory units) in each column are transferred in the horizontal direction by signal lines and input into the AD converter 901b. This horizontal direction (the longer direction of the focus detection sensor 901) will be called a “readout direction” in the present embodiment. In the present embodiment, the regions VCA921 and VCB922 have the same readout columns, and are therefore read out at the same timing. However, the regions HCA923 and HCB924 have different readout columns, and are therefore read out at different timings.

As described in the first embodiment, light leakage arises during the period when the signals are stored in the memory units, from when the accumulation ends to the readout. As such, light leakage arises in the same manner in the regions VCA921 and VCB922, which have the same periods from the end of the accumulation to the readout. However, the regions HCA923 and HCB924 have different periods from the end of the accumulation to the readout, and thus different amounts of light leakage arise in the regions HCA923 and HCB924. Error will arise in the focus detection if the waveforms of the pair of image signals are different in the aforementioned defocus computation.

Accordingly, in a configuration in which the pair of image signals used in the defocus computation are from different readout columns, the effect of light leakage can be reduced by reading out the regions of different readout columns preferentially. This is particularly useful when the light leakage is greater than or equal to the predetermined amount in step S704 described in the first embodiment, and thus the above-described readout order may be used when the light leakage amount is greater than or equal to the predetermined amount.

A readout pattern according to the second embodiment will be described next using the sensor state illustrated in FIG. 11.

In FIG. 11, the regions VCA921, VCB922, HCA923, and HCB924 detect the same region, and thus are set to the same accumulation time. The readout order has the regions HCA and HCB, which have different readout columns, read out first, after which the regions VCA and VBA, which have the same readout columns, are read out.

As described thus far, with a configuration in which the pupil division directions are different, reading out regions in which the readout columns are different preferentially makes it possible to reduce focus detection error causes by light leakage and carry out a highly-accurate focus detection process.

### Third Embodiment

In the first embodiment, an image for phase difference detection is exposed by the focus detection sensor 101. As method for determining the exposure amount in such a case, Japanese Patent Laid-Open No. 10-104502, for example, discloses a focus detection apparatus using a two-dimensional image sensor as a focus detection sensor. The exposure amount is controlled on the basis of a maximum accumulated charge amount for all of the pixels in the focus detection region of the two-dimensional image sensor. In this case, if the defocus amount is high, the main object may fall outside of the focus detection region, resulting in the exposure amount of the focus detection sensor being controlled on the basis of the brightness of the background or the like, rather than the main object. Accordingly, the present embodiment describes a configuration in which the exposure can be controlled to an appropriate amount regardless of the state of focus when the focus detection sensor controls the exposure.

A third embodiment of the present invention will be described next. The digital camera of the present embodiment has the same external configuration as the digital camera of the first embodiment, and thus descriptions thereof will not be given.

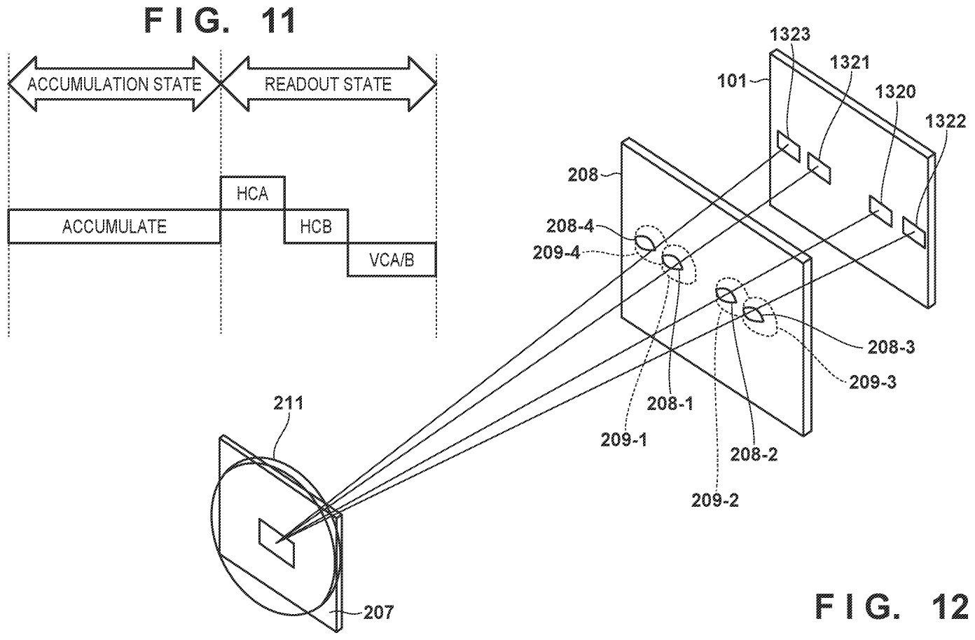

FIG. 12 is a diagram illustrating the configuration of an optical system pertaining to focus detection according to the third embodiment. The light beams from the object, reflected by the sub mirror 206, first form an image in the vicinity of the visual field mask 207 illustrated in FIG. 12. The visual field mask 207 is a light-blocking member for determining the focus detection region in the screen, and has a lengthwise opening in the center thereof.

The field lens 211 has an effect of causing each of openings in an aperture stop 208 to form images near the exit pupil of the shooting lens 200. Secondary image forming lenses 209-1 to 209-4, which are a total of four lenses constituting two pairs, are arranged behind the aperture stop 208, with each lens arranged so as to correspond to one of openings 208-1 to 208-4 in the aperture stop 208. The lens interval of the secondary image forming lenses 209-1 and 209-2 (called the “baseline length” hereinafter) is shorter than the baseline length of the secondary image forming lenses 209-3 and 209-4.

The light beams passing through the secondary image forming lenses 209-1 and 209-2 form images in a first region A 1320 and a first region B 1321 on the focus detection sensor 101. Likewise, the light beams passing through the secondary image forming lenses 209-3 and 209-4 form images in a second region A 1322 and a second region B 1323 on the focus detection sensor 101.

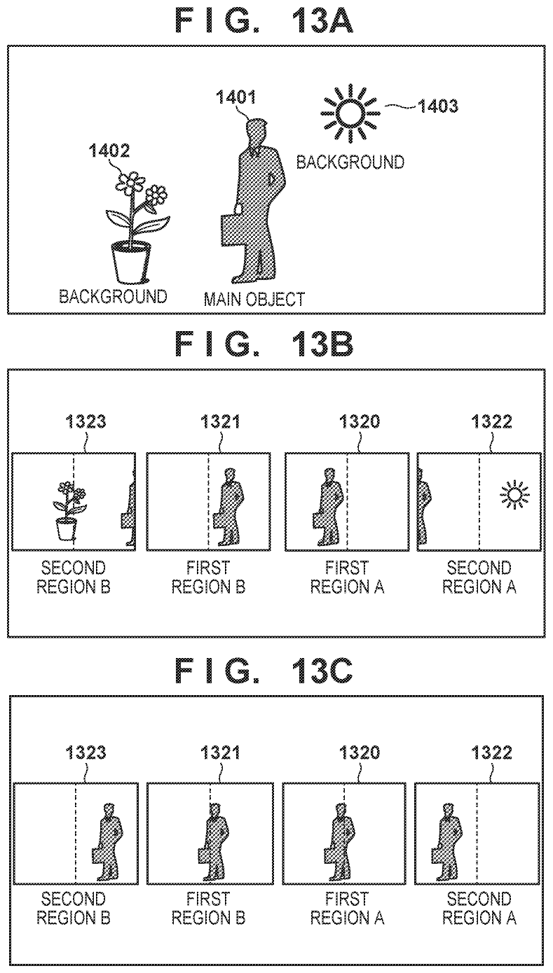

Next, the state of images formed on the focus detection sensor, resulting from the difference between the baseline lengths, will be described using FIGS. 13A to 13C. FIGS. 13A to 13C illustrate scenes in which the main object in the center is not in focus.

FIG. 13A illustrates an example of an image captured by the image sensor 106. The person 1401 in the center is the main object, while 1402 and 1403 indicate background objects. FIG. 13B illustrates an example of an image of the same scene as that in FIG. 13A, but captured by the focus detection sensor 101 through the optical system illustrated in FIG. 12, with a high defocus amount for the main object in the center.

In FIG. 13B, the image signals in the first region A 1320 and the first region B 1321, formed by the secondary image forming lenses 209-1 and 209-2 having the shorter baseline length, have a low phase difference. Thus an image of the main object 1401 is formed in the first region A 1320 and the first region B 1321, and the defocus amount can be calculated for the main object 1401.

On the other hand, the image signals in the second region A 1322 and the second region B 1323, formed by the secondary image forming lenses 209-3 and 209-4 having the longer baseline length, have a high phase difference. Accordingly, the main object 1401 is outside the second region A 1322 and the second region B 1323, and thus the defocus amount cannot be detected for the main object. In other words, it is preferable that the defocus amount be calculated on the basis of the image signals from the first regions when the defocus amount is high or the defocus state is unclear.

FIG. 13C illustrates an example of an image of the same scene as that in FIG. 13A, but captured by the focus detection sensor 101 through the optical system illustrated in FIG. 12, with a low defocus amount for the main object in the center.

In FIG. 13C, the image signals in the first region A 1320 and the first region B 1321, formed by the secondary image forming lenses 209-1 and 209-2 having the relatively short baseline length, have a low phase difference. Thus an image of the main object 1401 is formed in the first region A 1320 and the first region B 1321, and the defocus amount can be calculated for the main object 1401.

The phase difference between the image signals in the second region A 1322 and the second region B 1323, formed by the secondary image forming lenses 209-3 and 209-4 having the relatively long baseline length, is greater than the phase difference between the image signals in the first region A 1320 and the first region B 1321, but the main object 1401 is nevertheless formed. As such, in FIG. 13C, the defocus amount can be calculated from the image signals generated in either the first regions or the second regions.

In this manner, the phase difference between the second region A 1322 and the second region B 1323 is greater than the phase difference between the first region A 1320 and the first region B 1321, even if the defocus amount is the same. In other words, when the defocus amount is low, calculating the defocus amount on the basis of the image signals from the second regions having the longer baseline length provides a higher level of detection accuracy.

The amounts of light incident on the first regions and the second regions will be described next. Compared to the light beams incident on the first regions, the light beams incident on the second regions pass through the peripheral areas of the shooting lens 200. The effect of a decrease in the ambient light amount is thus high, which causes a drop in the signal level. The amount of light therefore differs between the first regions and the second regions by the amount of the decrease in the ambient light.

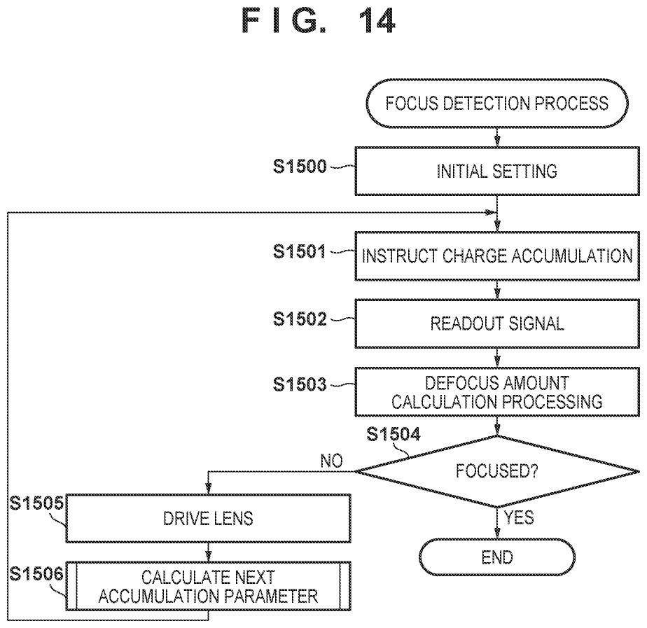

FIG. 14 is a flowchart illustrating operations in the focus detection process according to the present embodiment. When the CPU 100 receives a focus detection start signal in response to the switch group 114 being operated, the CPU 100 controls the focus detection sensor 101 to start the focus detection operations.

In step S1500, the CPU 100 carries out initial settings for the focus detection operations. The CPU 100 writes the initial settings into a register of the focus detection sensor 101, and sets the accumulation time for the initial accumulation.

In step S1501, the CPU 100 instructs the focus detection sensor 101 to start charge accumulation. Having received the instruction to start the charge accumulation, the focus detection sensor 101 resets the circuitry and the photodiodes, and starts the charge accumulation operations. Once an accumulation time set by the CPU 100 in advance has been reached, the charges accumulated in the photodiodes are transferred to memory units that are part of the peripheral circuitry of the photodiodes.

In step S1502, the CPU 100 reads out the signals accumulated by the focus detection sensor 101 in step S1501 from the memory units. In step S1503, the CPU 100 calculates a defocus amount for the signals read out in step S1502.

First, a known phase difference computation is carried out to detect the state of focus (defocus amount) of the shooting lens 200, using the image signals from the first region A 1320 and the image signals of the first region B 1321 corresponding thereto. The defocus amount (mm) is found by multiplying the phase difference (bit number) of the focus detection sensor 101 by optical coefficients such as the sensor pitch (mm) and the baseline length of the focus detection system.

In step S1504, the CPU 100 determines whether or not the shooting lens 200 is in focus on the basis of the defocus amount calculated in step S1503. The lens is determined to be in focus if the defocus amount is within a desired range, e.g., within ¼Fδ (where F is the aperture value of the lens and δ is a constant (20 μm)). For example, if the lens aperture value is F=2.0, the lens is determined to be in focus if the defocus amount is 10 μm or less, and the focus detection operations end. However, if the defocus amount is greater than 10 μm, the lens is determined not to be in focus, and the process moves to step S1505 in order to put the shooting lens 200 in focus.

In step S1505, the CPU 100 instructs the shooting lens 200 to be driven on the basis of the defocus amount, through the lens communication circuit 105. In step S1506, the CPU 100 calculates and sets the accumulation time of the focus detection sensor 101 for the next focus detection operations, on the basis of a signal amount accumulated by the focus detection sensor 101 (described later). The CPU 100 then returns the process to step S1500, and repeats the operations of steps S1501 to S1506 until the lens is determined to be in focus. The foregoing has described the flow of operations in the focus detection operations.

Next, FIG. 15 is a flowchart illustrating the calculation of accumulation control parameters for the next time, carried out in step S1506 of FIG. 14.

In step S1600, the CPU 100 determines whether or not there is defocus amount information. The process moves to step S1602 if the defocus amount could not be calculated in step S1503 of FIG. 14. A scene in which the object luminance is low and image signals cannot be detected, a scene in which pairs of image signals have different forms due to backlighting or the like, and so on can be given as examples of scenes in which the defocus amount cannot be calculated. However, if the defocus amount has been successfully calculated, the process moves to step S1601 to determine the defocus amount using the image signals from the first region.

In step S1601, the CPU 100 determines whether or not the defocus amount found from the image signals in the first regions is greater than a predetermined value. If the defocus amount is greater than the predetermined value, the process moves to step S1602. On the other hand, if the defocus amount is less than or equal to the predetermined value, the process moves to step S1603. The defocus amount detected from the image signals in the first regions is used as the defocus amount for this determination. This is because the main object is detected in the first regions regardless of the state of focus.

In step S1602, the defocus amount is greater than the predetermined amount, and thus the CPU 100 sets the first regions to a monitoring region for monitoring the signal amount accumulated in step S1501 of FIG. 14.

The reason why the monitoring region is set to the first regions will be described using FIG. 13B. In FIG. 13B, an image of the main object 1401 is formed in the first region A 1320 and the first region B 1321, which means that the signal amount for the main object can be detected in the first regions.

However, an image of the background object 1403 is formed in the second region A 1322, and an image of the background object 1402 is formed in the second region B 1323. The signal amounts of the background objects will therefore be detected in the second regions, and thus it is preferable that the monitoring region be set to the first regions rather than the second regions when the defocus amount is high or the defocus state is unknown.

In step S1603, the defocus amount is less than or equal to the predetermined amount, and thus the CPU 100 sets the second regions to the monitoring region for monitoring the signal amount accumulated in step S1501 of FIG. 14.

The reason why the monitoring region is set to the second regions will be described using FIG. 13C. In FIG. 13C, an image of the main object 1401 is formed in the first region A 1320 and the first region B 1321, which means that the signal amount for the main object can be detected in the first regions.

Additionally, an image of the main object 1401 is also formed in the second region A 1322 and the second region B 1323, which means that the signal amount for the main object can be detected in the second regions as well. However, the decrease in the ambient light amount has an effect as described earlier, and thus it is preferable that the second regions be monitored in order to optimize the signal amounts in the second region to be used in the next defocus amount detection.

In step S1604, the CPU 100 calculates the signal amount for the monitoring region set in step S1602 or step S1603. A method in which the average value of the pixel signals from the monitoring region as a whole is obtained can be given as an example of a method for calculating the signal amount of the monitoring region.

In step S1605, the CPU 100 sets parameters for the next instance of accumulation control. The accumulation time for the next instance of accumulation control is set on the basis of the signal amount calculated in step S1604 and the accumulation time set for the current instance of accumulation.

An example of a method for setting the accumulation time will be described here. First, the signal amount at which a predetermined focus detection accuracy is obtained is set as a target signal amount. If the obtained signal amount exceeds the target signal amount, the detection accuracy will improve, but the accumulation time will increase as well and the responsiveness will worsen. On the other hand, if the signal amount is less than the target signal amount, the S/N ratio will worsen, and the predetermined focus detection accuracy cannot be obtained.

It is therefore necessary to set the accumulation time appropriately in order to achieve the target signal amount. To set the accumulation time, if, for example, the signal amount in the monitoring region is half the target signal amount, the accumulation time may be set to double the previous accumulation time.

As described thus far, the monitoring region for calculating the accumulation control parameters is set to the first regions if the defocus amount is unknown or is greater than or equal to a predetermined amount. If the defocus amount is less than the predetermined amount, however, the monitoring region is set to the second region, and the focal position is controlled on the basis of the signal amount in the second regions, which provides a high focus detection accuracy.

Setting the monitoring region in this manner makes it possible to control the accumulation appropriately, which in turn makes a highly-accurate focus detection process possible.

### Fourth Embodiment

Like the third embodiment, the fourth embodiment describes a configuration in which the exposure can be controlled to an appropriate amount regardless of the state of focus when the focus detection sensor controls the exposure.

The fourth embodiment of the present invention will be described next. The digital camera of the present embodiment has the same external configuration as the digital camera of the first embodiment, and thus descriptions thereof will not be given.

FIG. 16 is a diagram illustrating the configuration of the optical system pertaining to focus detection. In FIG. 16, light beams 2201a and 2201b from a central object OBJ(Center) pass through pupils 2301a and 2301b of the shooting lens 200, and form an image on a focal plane P(Center) (a primary image formation plane) near the visual field mask 207. The light beams 2201a and 2201b are divided by secondary image forming lenses 209-1 and 209-2, which re-forms images on image forming areas 2501a and 2501b of the focus detection sensor 101. The defocus amount is found by calculating the correlation between the left and right object images.

Likewise, light beams 2202a and 2202b pass through pupils 2302a and 2302b of the shooting lens 200, and form an image on the focal plane P(Center) (the primary image formation plane) near the visual field mask 207. The light beams 2202a and 2202b are pupil-divided by secondary image forming lenses 209-3 and 209-4, which re-forms images on image forming areas 2502a and 2502b of the focus detection sensor 101. The defocus amount is found by calculating the correlation between the top and bottom object images. The images formed in the respective image forming areas will be called an “A image” and a “B image”.

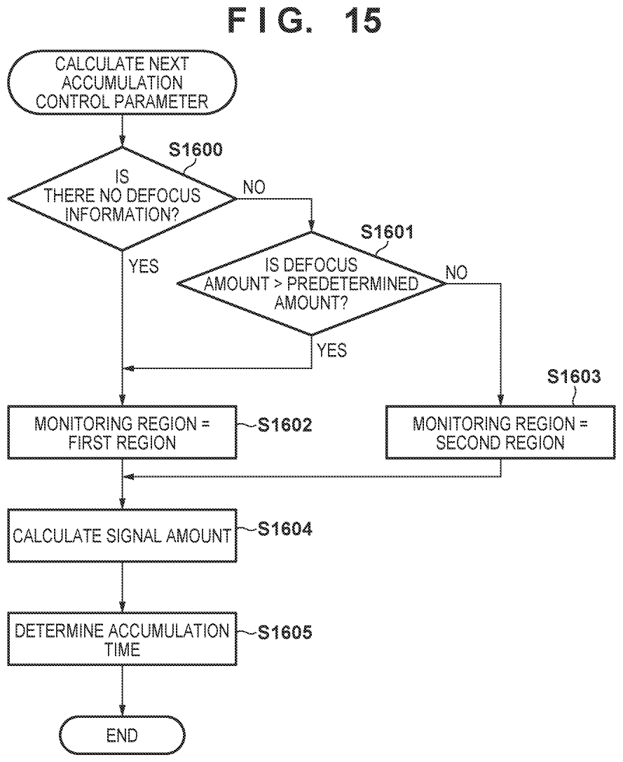

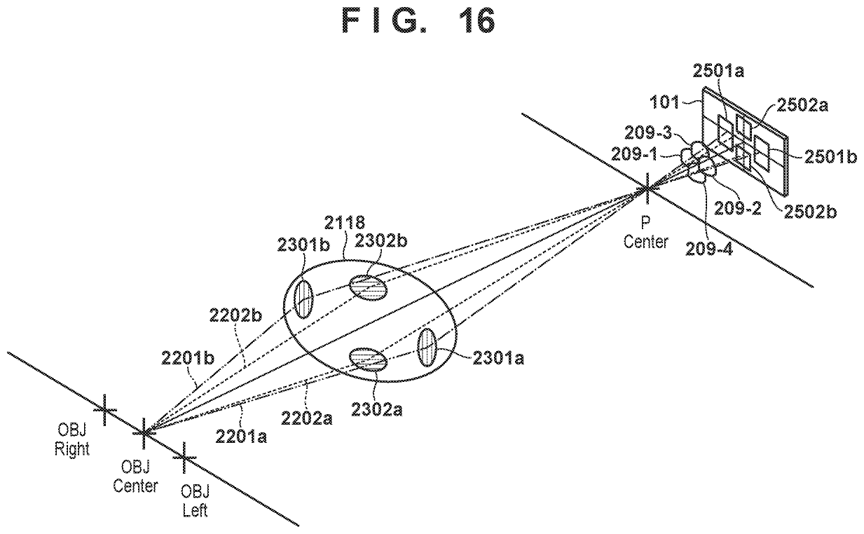

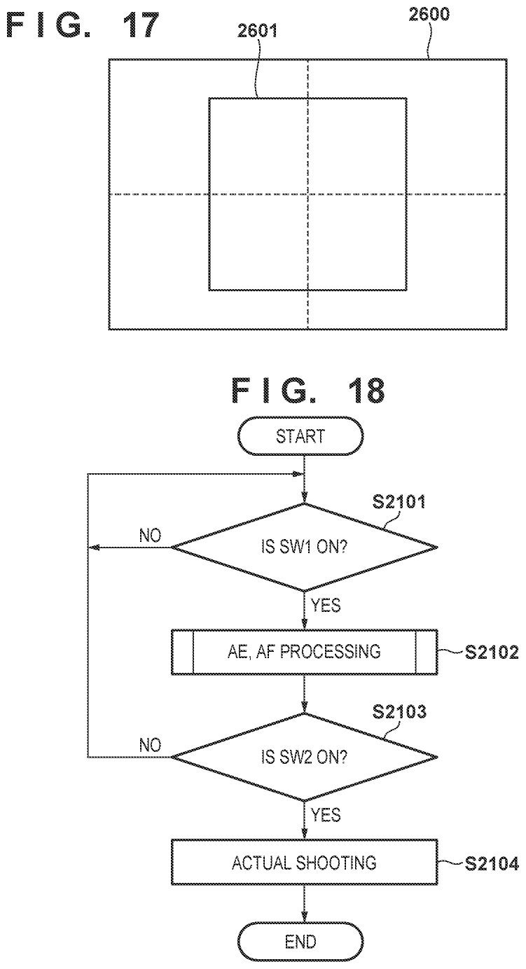

FIG. 17 is a diagram illustrating the relationship between a viewfinder screen and an AF region. An AF region 2601 is arranged in a viewfinder screen 600. The AF region 2601 is an AF region formed by the image forming areas 2501a and 2501b and the image forming areas 2502a and 2502b.

FIG. 18 is a flowchart illustrating the sequence of an image capturing control process according to the present embodiment. The processing illustrated in FIG. 18 is carried out by the CPU 100 executing programs stored in memory, and assumes that the camera body 150 has already been started up.

First, in step S2101, the CPU 100 determines whether or not a switch SW1, which turns on when a shutter switch (not shown) for making a shooting instruction is pressed halfway, is on. If the switch SW1 is on, the process moves to step S2102. If the switch SW1 is not on, the system stands by.

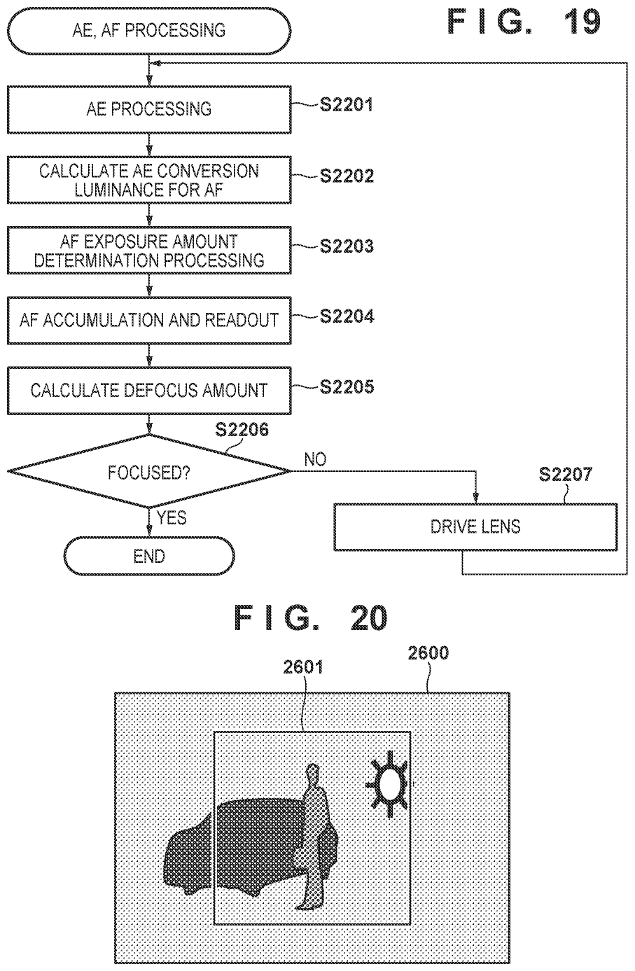

In step S2102, the CPU 100 controls the photometry sensor 107 and the focus detection sensor 101 to carry out an AE process and a phase difference autofocus (AF) process, and sends the calculated defocus amount to the shooting lens 200. The shooting lens 200 moves the focus lens to a focusing position on the basis of the received defocus amount. The AE process and the AF process will be described in detail later with reference to the flowchart in FIG. 19.

In step S2103, the CPU 100 determines whether or not a switch SW2, which turns on when the aforementioned shutter switch is fully pressed, has turned on. If the switch SW2 is on, the process moves to step S2104. If the switch SW2 is not on, the process returns to step S2101.

In step S2104, the CPU 100 carries out an actual shooting process, and ends the processing of this flowchart.

FIG. 19 is a flowchart illustrating the sequence of the AE process and AF process carried out in step S2102 of FIG. 18.

In step S2201, the CPU 100 carries out the AE process by controlling the photometry sensor 107. A photometry value including luminance information of an object under stationary light (called a “photometry value under stationary light” hereinafter) is obtained as a result. Exposure control values used during shooting, such as the aperture value and ISO sensitivity, are determined on the basis of the photometry value under stationary light.

In step S2202, the CPU 100 converts the photometry value calculated in step S2201 into a luminance of light received by the focus detection sensor 101. A luminance YAF(AE) obtained from the conversion is calculated through the following formula, with TVAE representing the exposure amount of the photometry sensor 107, YAE representing the sensor output, and ΔS representing a sensor sensitivity difference including a difference between the light amounts in the optical systems.

YAF(AE)=YAE+TVAE+ΔS

In step S2203, the CPU 100 determines the next AF exposure amount using the AE conversion luminance for AF, calculated in step S2202, and an AF luminance calculated from the previous image obtained by the focus detection sensor 101. This process will be described in detail later. In step S2204, the CPU 100 reads out the result of exposing the focus detection sensor 101 at the exposure amount determined in step S2203.

In step S2205, the CPU 100 calculates a defocus amount from the pixel signals from each image forming area, obtained in step S2204. Image signals are obtained from the pixel outputs of a pair of image forming areas. The state of focus (defocus amount) of the shooting lens 200 is then detected from the phase difference between the image signals.

With respect to the defocus amount calculation result, if the user has selected a desired focus detection region (free AF selection), a result of processing the image signals in a corresponding image forming area is used for the defocus amount. In the present embodiment, image forming areas for detecting vertical lines and horizontal lines are provided. Although the method for selecting the image forming area is not particularly limited, an image forming area thought to be able to obtain a highly-reliable defocus amount, such as where the waveforms of the image signals have a high correlation or the contrast is high, is selected. The selected image forming area is taken as a “main area”.

If the user has chosen the focus detection region to be automatically selected (automatic AF selection), one defocus amount is selected from among the vertical and horizontal line detection results in the entire screen. Although the selection method is not particularly limited, an amount thought to be a highly-reliable defocus amount, such as where the waveforms of the image signals have a high correlation or the contrast is high, is selected. The selected area is taken as the “main area”.

In step S2206, the CPU 100 determines that the lens is in focus if the defocus amount is within a predetermined range, e.g., within ¼Fδ (where F is the aperture value of the lens and δ is a constant (20 μm)). For example, if the lens aperture value is F=2.0, the lens is determined to be in focus if the defocus amount is 10 μm or less, and the AF process ends.

On the other hand, if all defocus amounts are greater than ¼Fδ, in step S2207, the CPU 100 instructs the shooting lens 200 to drive by an amount corresponding to one of the defocus amount for each focus detection region found in step S2205. The CPU 100 then returns the process to step S2201, and repeats the operations of steps S2201 to S2207 until the lens is determined to be in focus. Although the method for selecting the defocus amount in step S2205 is not limited, the defocus amount in the focus detection region corresponding to the object that is closest may be selected, for example.

Next, the AF exposure amount determination process of step S2203 in FIG. 19 will be described. FIG. 20 is a diagram illustrating an example of a composition obtained by a camera. Assume that the user has selected the center area through free AF selection and is attempting to shoot an image of the person. In this composition, the user specifies the AF region 2601 in the focus detection sensor 101. The ranges in which images are formed in the AF region 2601 shift in accordance with the state of focus of the lens.

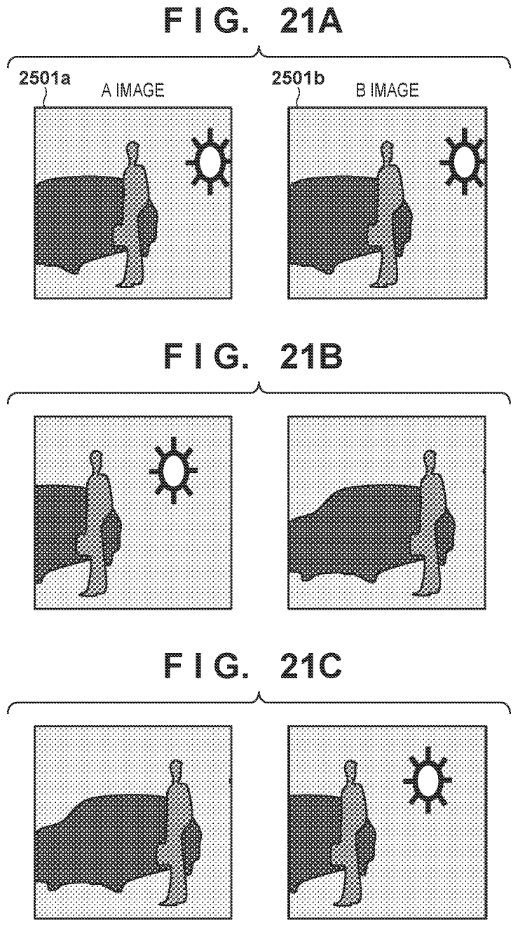

FIGS. 21A to 21C are diagrams illustrating the ranges in which images are formed in the image forming areas 2501a and 2501b of the focus detection sensor 101. When the lens is near an in-focus state, the A image and the B image are formed in the same range, as indicated in FIG. 21A. However, when there is significant defocus, the ranges in which the A image and the B image are formed change. The images are formed as indicated in FIG. 21B when the focal point of the lens is at infinity, and as indicated in FIG. 21C when the focal point of the lens is at the near end.

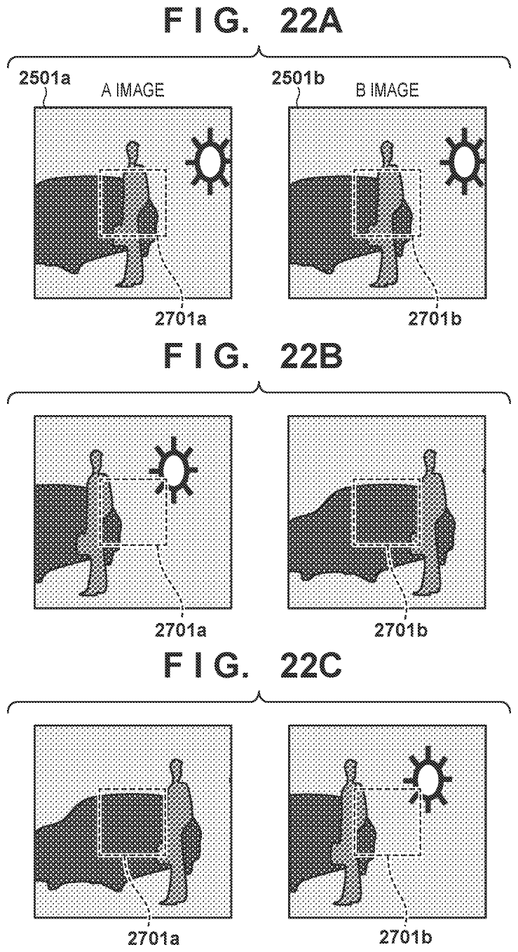

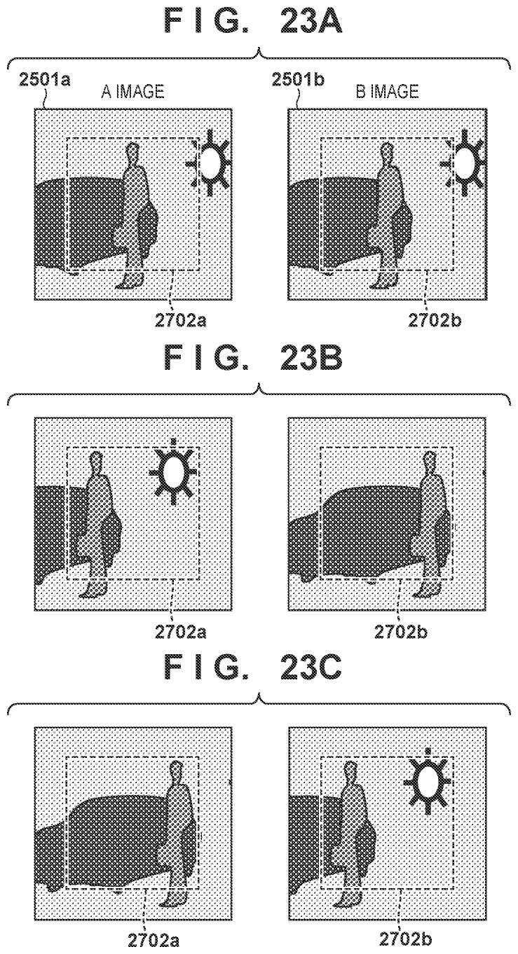

The ranges for determining the exposure amount will be called the “AF luminance calculation regions”. If the AF luminance calculation regions are set to small ranges as indicated by regions 2701a and 2701b in FIGS. 22A to 22C, the main object will not fit within the AF luminance calculation region ranges when the defocus amount is high. As such, the exposure amount cannot be calculated appropriately. However, if the AF luminance calculation regions are set to broad ranges as indicated by regions 2702a and 2702b in FIGS. 23A to 23C, other objects will be present in the above-described ranges, and thus the exposure amount cannot be calculated appropriately in this case, either.

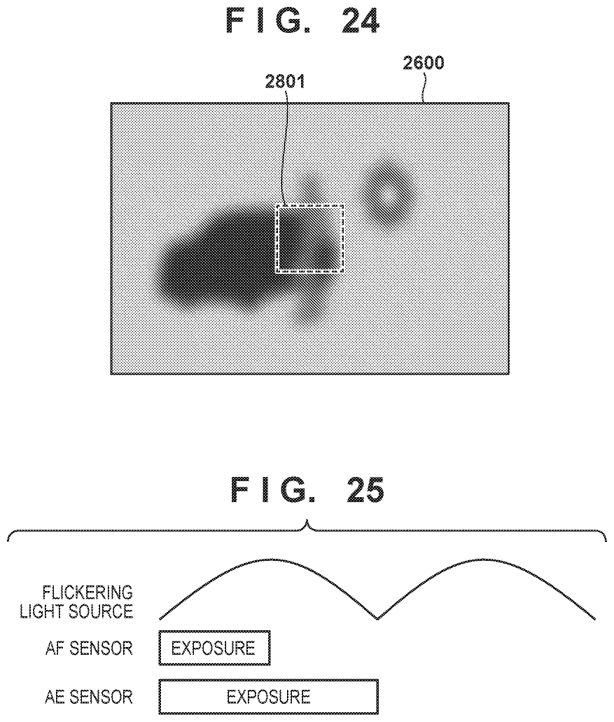

FIG. 24 is a diagram illustrating an example of an image when the foregoing composition is shot by the photometry sensor 107 at a high defocus amount. An image formed on the focusing plate of the camera body 150 is obtained, and the image is thus out of focus. The photometry sensor 107 is provided with an AF luminance calculation region 2801, and calculating the luminance within this region makes it possible to obtain the luminance of the main object with a higher accuracy than when using the focus detection sensor 101.

Utilizing this property, the luminance of the AF luminance calculation region 2801 is calculated by the photometry sensor 107 and converted into an AE conversion luminance for AF to determine the AF exposure amount, when the defocus amount is, or may be, high. In other cases, the AF exposure amount is determined using the AF luminance in the AF luminance calculation region 2701a or 2701b in the focus detection sensor 101.

To be more specific, in the initial time, when the defocus state is unknown, the AF exposure amount is determined using the AE conversion luminance for AF, calculated in step S2202 of FIG. 19 using the photometry values of the photometry sensor 107. Even if it has been known, due to the result of the previous process of step S2205, that the defocus amount is high, the AF exposure amount is determined using the AE conversion luminance for AF calculated in step S2202.

The determination as to whether or not the defocus amount is high may be made using a measured luminance value. For example, all or some of the previous AF luminances and the AE conversion luminances for AF may be compared, and the defocus amount is determined to be high when a difference between the luminances is high.

When shooting under a flickering light source as indicated in FIG. 25, the AF exposure amount is determined using the AE conversion luminance for AF (the AE detection result), even when the accumulation time of the focus detection sensor 101 is shorter than the cycle at which the light source flickers and the accumulation time of the photometry sensor 107 is greater than or equal to the cycle at which the light source flickers.

At this time, the exposure amount may be adjusted in accordance with where the accumulation timing of the focus detection sensor 101 (the exposure timing) matches the phase of cycle at which the light source flickers. For example, the exposure amount is reduced when exposing at the peaks of the flicker cycle and increased when exposing at the valleys of the flicker cycle.

The ranges of the above-described AF luminance calculation region and AE luminance calculation region for AF are changed between free AF selection and automatic AF selection. In other words, the region specified by the user is used during free selection. During automatic selection, a region covering the AF region 2601 is used.

Although preferred embodiments of the present invention have been described above, the present invention is not intended to be limited to these embodiments, and many variations and alterations are possible within the scope thereof.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-178082, filed on Sep. 21, 2018, which is hereby incorporated by reference herein in its entirety.

What is claimed is:

1. An image capturing apparatus comprising:
an area sensor in which photoelectric conversion elements are arranged two-dimensionally, the sensor having a plurality of regions; and
at least one processor or circuit configured to function as the following units:
an exposure control unit that causes the area sensor to be exposed at a given exposure time so that accumulation ends at substantially the same time for the plurality of regions, and reads out, in order, image signals accumulated as a result of the exposure; and
a focus detection unit that carries out focus detection using a signal read out from the area sensor,
wherein the exposure control unit carries out control for prioritizing the readout of signals from the photoelectric conversion elements in a region or regions among the plurality of regions.

2. The image capturing apparatus according to claim 1,
wherein the exposure control unit prioritizes the readout of the signals of a region, among the plurality of regions, in which a main object is present.

3. The image capturing apparatus according to claim 1,
wherein the exposure control unit prioritizes the readout of the signals of a region, among the plurality of regions, in which an object luminance is high.

4. The image capturing apparatus according to claim 1,
wherein the exposure control unit prioritizes the readout of a region, among the plurality of regions, in which the exposure time of the photoelectric conversion elements, determined in accordance with an object, is short.

5. The image capturing apparatus according to claim 1,
wherein the exposure control unit prioritizes the readout of the signals from a region, among the plurality of regions, in which a main object is present, and then prioritizes the readout of a region in which an object luminance is high or in which the exposure time of the photoelectric conversion elements is short.

6. The image capturing apparatus according to claim 1,
wherein the exposure control unit can transfer signals accumulated in the photoelectric conversion element to memory along with ending the accumulation;
wherein the at least one processor or circuit is configured to function as a calculation unit that calculates an amount of signals produced in the memory; and
wherein the exposure control unit prioritizes the readout of a region, among the plurality of regions, in which the amount of the signals produced in the memory is greater than a predetermined amount.

7. The image capturing apparatus according to claim 1,
wherein object images passing through different partial regions of a pupil region of a shooting lens are formed in the plurality of regions, and each of the plurality of regions has a different baseline length for focus detection; and
wherein the exposure control unit carries out control for prioritizing the readout of signals from the photoelectric conversion elements in a region or regions among the plurality of regions in accordance with a degree of defocus of an object.

8. The image capturing apparatus according to claim 7,
wherein the exposure control unit determines the next exposure amount of the photoelectric conversion elements on the basis of the signals from the photoelectric conversion elements in the region read out with priority.

9. The image capturing apparatus according to claim 7,
wherein when the defocus amount of the object is greater than a predetermined amount, the exposure control unit prioritizes the readout of signals from the photoelectric conversion elements in a region, among the plurality of regions, in which the baseline length is relatively short.

10. The image capturing apparatus according to claim 7,
wherein when the defocus amount of the object is less than or equal to a predetermined amount, the exposure control unit prioritizes the readout of signals from the photoelectric conversion elements in a region, among the plurality of regions, in which the baseline length is relatively long.

11. The image capturing apparatus according to claim 9,
wherein the focus detection unit detects the defocus amount of the object used to determine the region to be read out with priority, using the signals from the photoelectric conversion elements in the region, among the plurality of regions, in which the baseline length is relatively short.

12. The image capturing apparatus according to claim 1, further comprising:
a photometry sensor that detects the luminance of an object,
wherein the exposure control unit switches between controlling the exposure amounts of the plurality of regions on the basis of the signals from the photoelectric conversion elements in the plurality of regions, and controlling the exposure amounts of the plurality of regions on the basis of signals from the photometry sensor.

13. The image capturing apparatus according to claim 12,
wherein in the first instance of focus detection, the exposure control unit controls the exposure amounts of the plurality of regions on the basis of signals from the photometry sensor.

14. The image capturing apparatus according to claim 12,
wherein when the defocus amount of the object is greater than a predetermined amount, the exposure control unit controls the exposure amounts of the plurality of regions on the basis of signals from the photometry sensor.

15. The image capturing apparatus according to claim 12,
wherein when a difference between the signals from the photoelectric conversion elements in the plurality of regions and the signals from the photometry sensor is greater than a predetermined amount, the exposure control unit controls the exposure amounts of the plurality of regions on the basis of the signals from the photometry sensor.

16. The image capturing apparatus according to claim 12,
wherein when the exposure time of the photoelectric conversion elements in the plurality of regions is shorter than the cycle at which a light source flickers, and an exposure time of the photometry sensor is greater than or equal to the cycle of the flickering, the exposure control unit controls the exposure amounts of the plurality of regions on the basis of the signals from the photometry sensor.

17. The image capturing apparatus according to claim 12,
wherein when a light source flickers, the exposure control unit adjusts a detection result from the photometry sensor in accordance with the timing of the exposure of the photoelectric conversion elements in the plurality of regions.

18. A method for controlling an image capturing apparatus, the apparatus including an area sensor that has photoelectric conversion elements arranged two-dimensionally and that has a plurality of regions, the method comprising:
exposing the area sensor at a given exposure time so that accumulation ends at substantially the same time for the plurality of regions, and reading out, in order, image signals accumulated as a result of the exposure; and
carrying out focus detection using a signal read out from the area sensor,
wherein in the exposing, control is carried out for prioritizing the readout of signals from the photoelectric conversion elements in a region or regions among the plurality of regions.

19. A non-transitory computer-readable storage medium storing a program for causing a computer to execute the steps of a method for controlling an image capturing apparatus, the apparatus including an area sensor that has photoelectric conversion elements arranged two-dimensionally and that has a plurality of regions, and the method comprising:
exposing the area sensor at a given exposure time so that accumulation ends at substantially the same time for the plurality of regions, and reading out, in order, image signals accumulated as a result of the exposure; and
carrying out focus detection using a signal read out from the area sensor,
wherein in the exposing, control is carried out for prioritizing the readout of signals from the photoelectric conversion elements in a region or regions among the plurality of regions.
